(19) United States
(12) Patent Application Publication
(10) Pub. No.: US 2013/0163233 A1
(43) Pub. Date: Jun. 27, 2013

(54) ILLUMINABLE PANEL

(71) Applicant: Inventio AG, Hergiswil (CH)

(72) Inventors: Gunther NIEDERMAYER, Wien (AT); Michael Matheisl, Vosendorf (AT)

(73) Assignee: Inventio AG, Hergiswil (CH)

(21) Appl. No.: 13/718,236

(22) Filed: Dec. 18, 2012

(30) Foreign Application Priority Data
Dec. 21, 2011 (EP) 11194843.6

(51) Int. Cl. F21S 8/00

(52) U.S. Cl. CPC F21S 8/00
USPC 362/146

(57) ABSTRACT

An escalator, a moving walkway or an elevator cage has at least one illuminable panel. The illuminable panel has a construction containing a plurality of layers. The two side surfaces of each layer are bounded in the area dimension thereof by an edge region. The layers of the construction lay by the side surfaces one on the other. The layer sequence of the construction is defined, wherein a first layer is a reflective covering, a second layer is a transparent polymer material plate containing light-dispersing particles, a third layer is a first glass pane, a fourth layer is a transparent polymer layer and a fifth layer is a second glass pane.

### CROSS-REFERENCE TO RELATED APPLICATION

This application claims priority to European Patent Application No. 11194843.6, filed Dec. 21, 2011, which is incorporated herein by reference.

### FIELD

The disclosure relates to an illuminable panel for an escalator, a moving walkway or an elevator cage.

### BACKGROUND

Elevators are used not only in the private sector, but also in the public sector. A pleasant, sufficiently bright lighting and a decorative interior furnishing significantly influence the mood of the user in the elevator cage.

Escalators and moving walkways are used almost exclusively in the public sector, particularly in the area of public traffic, for example in railway stations, underground stations, department stores, shopping centers as well as in larger hotels. They generally comprise a support structure and at least one plate belt or step belt, which is arranged in the support structure and movable in its longitudinal direction and with which lateral stationary balustrades are connected. The balustrades have metal panels or glass panels which are fastened to the support structure by means of a balustrade base. A handrail moving with the plate belt or step belt is arranged above each balustrade.

Escalators and moving walkways usually have lighting systems which increase the comfort of the users and contribute to avoidance of accidents. Known lighting systems for moving walkway and escalator installations are designed so that only certain regions of the moving walkway or escalator installations are lit. These regions are located between the balustrades. For example, only an upper region with the handrail, a lower region in which the balustrades and the plate belt or step belt impinge or those regions by way of which the moving walkway or escalator installations are entered or left are lit.

Escalators and moving walkways particularly in department stores, shopping centers and larger hotels have for many years been incorporated into the design concepts of the buildings. They serve not only for pure transport of users, but also as design features of interior and exterior spaces of the building. Thus, the balustrade claddings, side claddings and under-view claddings are available covered in the most diverse colors and materials to correspond with the individual wishes of the operator.

It is sometimes expected by operators that the surface, which is paneled with painted or covered panels, of an escalator or moving walkway has a unitary appearance. Thus, the individual panels should have a uniform color tone, a uniform color saturation and a uniform brightness.

Similar desires can also apply to the internal furnishing of elevator cages. In order to impart to the user a sense of security, an appearance which is as clean and homogenous as possible should be present. Scratched or damaged cage walls, deficient lighting or brighter and darker spots of the illuminated surfaces of the cage interior space can promote user concern.

### SUMMARY

At least some embodiments of the present invention comprise an illuminable panel which can be illuminated by at least one lighting means. The lighting means is arranged at at least one edge region of the illuminable panel. The illuminable panel has a construction containing a plurality of layers. The two side surfaces of each layer are bounded in the area dimension thereof by an edge region. The layers of the construction lay one against the other by their side surfaces, i.e. the layers are layered one on the other by the side surfaces thereof in order to obtain the desired construction. The layer sequence of the construction is defined, wherein a first layer is a reflective covering, a second layer is a transparent polymer material plate which can be lit at the edges and contains light-dispersing particles, a third layer is a first glass pane, a fourth layer is a transparent polymer layer and a fifth layer is a second glass pane.

In particular embodiments, so that the panel can deliver the light, which is supplied to the edge region, uniformly over the side surface bounded in the area extent thereof by the edge region, a special optical conductor can be used. For some time, transparent polymer material plates, which can be lit at the edges, of polymethylmethacrylate (PMMA) having additional transparent light-dispersing particles, have been available in the trade. These polymer material plates have the desired optical conducting property by virtue of the embedded light-dispersing particles. They are edge-lit and uniformly distribute light, which is fed thereto in the edge region, over the side surfaces, which are bounded in the area dimension thereof by the edge region, of the polymer material plate. The entry area of the light is possibly arranged orthogonally to the exit area of the light so as to avoid light concentrations at the side surface. By virtue of these characteristics, an illuminable panel can be constructed very economically and simply. In addition, the lighting means can be arranged laterally of the polymer material plate, which substantially simplifies maintenance thereof and can lead to a very compact construction of the illuminable panel.

In principle, these polymer material plates irradiate by way of both side surfaces. In the case of desired irradiation at one side the rear side surface can be provided with a reflective covering. The irradiating side surface can additionally be covered by an information carrier, for example a motif film, and have a protective covering, for example of scratch-proof glass.

The use of the afore-described optical conductor for edge-illuminable panels can, however, conceal the features mentioned in the following, which may not lead to the desired characteristics of the illuminable panel. The coverings or the information carriers may not, according to manufacturer instructions, be glued or laminated over the whole area to the polymer material plate, since in the case of optical contact disruptive brightened areas and darkened areas would be created. In the case of construction from edge-illuminable panels with the afore-described polymer material plates, an appropriate spacing between the individual layers therefore can be observed so that they never bear against one another. Due to these requirements, however, large-area horizontal illuminable panels with a uniform appearance cannot necessarily be realized, since the individual layers of the panels of multi-layered construction warp differently and this would lead to optical contacts. Escalators, moving walkways and elevator cages can, however, in accordance with the wish of operators also be equipped with horizontal illuminable panels for under-view claddings or cage roofs. Moreover, the spacing of the individual layers leads to thick panels, which, used as side cladding, substantially increase the width of the escalator, moving walkway or elevator cage. In addition, due to the spacing of the layers in the panel chambers are created in which condensation water can form.

Vibrations caused by the users of an escalator, a moving walkway or an elevator could in addition lead to temporary optical contacts not only in a case of upright panels, but also in a case of horizontal panels. Due to the temporary optical contacts, moving bright areas and dark areas are produced which could lead to insecurity of users and deter them from using the escalator, moving walkway or elevator.

Although the side surfaces of the polymer material plates are provided by manufacturers with protective films, these can after transport, storage or cutting to size nevertheless have scratches. Without edge illumination these are often barely recognizable just by the eye, but the light issuing from the surface is focused very strongly and disrupts the optical impression of the illuminated panel.

The aforesaid points can have the consequence that the polymer material plates, which can be lit at the edges, with light-dispersing particles previously did not appear suitable for producing edge-illuminable panels for escalators and moving walkways. In the case of elevators, they can be at most usable for roof illuminations, but due to possible temporary optical contacts only without a protective covering.

Through the defined layer sequence of the construction comprising a plurality of mutually contacting layers could a uniform light distribution over the area dimension, which is bounded by the edge region, of the panel be achieved and a homogeneously lit side surface created. A core importance in that case attaches to the third, fourth and fifth layers. The third layer and the fifth layer are glass panes which have a refractive index, which is typical for glass, of 1.45 to 2.14 (dimensionless size). The fourth layer, which is a transparent polymer layer, has a refractive index in the region of the 1.48 to 1.56. In the case of use of different materials it is improbable that the polymer layer has exactly the same refractive index as the two glass panes, but the two refractive indices differ only slightly from one another. This can mean that the light focused by scratches in the surface of the polymer plate of the second layer and by optical contacts between the first and second layers and between the second and third layers is dispersed without being perceptibly resolved into spectral colors. Even observed from a small distance, the illuminated panel has by virtue of this construction a uniformly lit side surface.

If in the present specification mention is made of a uniform or homogenous light distribution over the side surface this does not mean that every region of the side surface of the illuminable panel has to have exactly the same radiation output. Thus, the edge region of the side surface can by virtue of the closer position to the lighting means have a distinctly slightly higher light density than the center of the side surface of the illuminable panel. A uniformly or homogeneously lit side surface can clearly and plainly signify the absence of light concentrations such as visible scratches, optical contacts and notably perceptible bright and dark spots distributed over the side surface, such as can take place as a consequence of superimposition of the cones of light of a plurality of lighting means.

In the first successful tests the glass pane serving as third layer was glued to a transparent plastics material film serving as fourth layer and a further glass pane attached as fifth layer. The unexpectedly good result and analysis of the layer sequence led to further tests. In one of these tests it was ascertained that the first glass pane, the transparent polymer layer and the second glass pane can be replaced by a composite glass pane in order to achieve the same effect. The transparent polymer layer can thus be a plastics material film or a polymer adhesive.

The layers of the construction can be held together by suitable means to form an edge-illuminable panel. These can be frames which are formed from U-sections and which embrace the edge regions of all layers. Insofar as the reflective covering has an inherent stability and, for example, consists of sheet steel or sheet aluminum, this can be constructed as a mount for the further layers. For that purpose the edge region of the reflective covering can be flanged at at least one edge section. The edge regions of the other mutually contacting layers of the illuminable panel are framed in this edge section by the flanged edge region. Depending on the respective design of the panel construction the non-flanged edge regions can be framed by U-sections, angle sections or Z-sections or the layers fixed by means of fastening elements such as springs, screws, clips and the like to the reflective covering.

Insofar as the lighting means are to be arranged in the flanged edge section, the flanged edge section can have at least one passage matched to a position and size of the at least one lighting means. A number of lighting bodies such as fluorescent tubes, light-emitting diodes, cold-cathode lamps and the like can be used as lighting means. In addition, an OLED (organic light-emitting diode) encircling the edge region of the polymer material plate is also possible. If, for example, a row of light-emitting diodes is used as lighting means the flanged edge section can have a row of passages, in which case the pitch of the light-emitting diodes corresponds with the pitch of the passages.

An escalator or a moving walkway in most cases has side surfaces and a large under-view area, whilst an elevator cage has large cage wall surfaces and a large roof area. All these surfaces can be clad by at least one illuminable panel. In order to facilitate mounting, the at least one illuminable panel can be subdivided into a plurality of panel sections. Each panel section then has the construction composed of a plurality of mutually contacting layers.

Through the construction of the panel or the panel section having a plurality of layers it is possible for gaps to be present between the individual layers even when the layers bear closely against one another or are pressed against one another by a clamping frame. The gap width of the gaps depends on the non-planarity of the side surfaces and the stiffness of the individual layers which, layered one on the other, give rise to the construction of the panel. These gaps are very narrow and have a high degree of capillarity. In order to prevent, for example, rainwater collecting in the gaps of the panels the gaps can be sealed in encircling manner in the edge regions of the layers by means of a sealing element. The sealing element has a joint depth of 0.2 millimeters to 20 millimeters between the layers. However, the joint depth is preferably 8 millimeters to 12 millimeters. Tightness is thereby securely provided and the sealing element can be concealed without problems by the flanged edge region of the reflective covering or by decorative strips without covering too much of the illuminable side surface of the panel. The sealing element can, for example, be an adhesive foil with a sealing adhesive film, but also a layer of a hardenable paste such as silicon rubber and the like.

In order that the entry of the light emitted by the lighting element into the polymer material plate of the second layer is not obstructed the sealing element can have a cut-out matched to the lighting means and the second layer.

In order to obtain an identical optical impression from two panel sections arranged adjacent to one another the light flux, which is to be introduced, of the lighting element of each panel section can also be differentiated, since the individual panel sections can have side surfaces and contours of different size. Possibly, an individual lighting means settable in light intensity and/or in color tone and/or in color saturation is therefore associated with each panel section.

In addition, at least one sensor can be associated with each panel section. This can be just a single sensor, which detects, as sensor signal, a digitalized image, the image regions of which can be associated with the individual panel sections by means of an image processing program. A CCD sensor, for example, is suitable as sensor. The light intensity, color tone and color saturation of the individual image regions can be compared with one another by the image processing program. Regulating data and/or regulating signals, which can be supplied to a control unit, can be calculated from this comparison. The control unit regulates the lighting means of the panel sections with consideration of the regulating data and/or regulating signals.

However, as many sensors as panel sections can also be present, these sensors possibly being arranged at suitable points in the panel. Obviously, also several sensors per panel section are usable. These sensors can also detect the light intensity and/or the color tone and/or the color saturation of the associated lit panel section. The signal of the at least one sensor can be supplied to a control unit and processed by this.

The control unit can be a computer unit independent of the escalator or the moving walkway, but it can also be a part of a control of the escalator or the moving walkway. For example, the control unit can recognize on the basis of the sensor signal whether or not all panel sections are lit. In addition, the sensor signal can be utilized for regulation of the light intensity and/or color tone and/or color saturation of the associated panel section. This can make it possible to selectably switch the panel sections, to vary the color tone, color saturation and light intensity and to influence, through these lighting accents, the awareness and mood of the user. Thus, for example, aggression and anxiety can be moderated by a warm, soft lighting and the risk of vandalism reduced. The change to lighting having a less pleasant, cold or dazzling effect can have the consequence that undesired persons quickly leave the environment of, for example, the escalator or the moving walkway.

If at least two panel sections are present, one of the panel sections can be defined as master and predetermine the light intensity and/or the color tone and/or the color saturation. The remaining panel sections can be defined as servant, in which case the light intensity and/or the color tone and/or the color saturation thereof can be adapted by the control unit to the panel section defined as master.

Obviously, the fifth layer can be covered by a motif film or be provided with printing, so that when the lighting means is switched on the motif film or the printing is backlit by the illuminable panel. The imprints and motif films can, in addition, be protected by means of a further glass pane which covers these and the fifth layer.

The illuminable panel can be used at multiple sides in an escalator or a moving walkway. An escalator or a moving walkway comprises a support structure, at least one step belt or plate belt arranged in the support structure and a respective balustrade arranged at the support structure and extending at each longitudinal side of the step belt or plate belt. The support structure has large side areas and a large under-view area. In addition, large balustrade side surfaces are present. All of these surfaces can be provided or clad with an illuminable panel according to the wish of the operator. The escalator or moving walkway should have, for each illuminable panel, at least one lighting means which is arranged in the edge region of the illuminable panel.

For example, the at least one illuminable panel can be an under-view cladding panel or a side cladding panel. The reflective covering thereof is directed towards the support structure so that the illuminable side surface of the illuminable panel can be seen by the user of the escalator or the moving walkway.

Moreover, the at least one illuminable panel can also be a balustrade cladding panel of the balustrade, wherein the reflective covering thereof is directed towards an inner structure of the balustrade. Two illuminable panels with inherently stable reflective coverings can also lie against one another and form a balustrade or a balustrade section, wherein the inner structure is formed by the mutually contacting inherently stable reflective coverings. If the balustrade cladding panel is directed by its illuminable side surface towards the step belt or plate belt this region is extremely well lit. Due to the large-area distribution of the light over the side surface of the illuminable panel the users are not dazzled.

Moreover, the at least one illuminable panel can also be a protective device or part of a protective device, the reflective covering of which is arranged in the side of the panel facing away from the field of view of a user of the escalator or the moving walkway. This protective device can be a deflector which prevents abusive users from moving-walkway or escalator ‘surfing’. The protective device can also be means which safeguard against falling down and which extend parallel to the balustrade and prevent or at least hinder climbing over the balustrade.

However, the protective device does not have to be permanently dominant in appearance. The illuminable panel of the protective device is possibly illuminated only when the user is to be warned. In order to achieve this, for example, a predetermined region around the protective device can be monitored by a movement sensor connectible with a control of the escalator or the moving walkway. In the case of imminent risk the lighting means is switched on to emit possibly red light as soon as a user has entered the predetermined region.

Instead of a movement sensor or in combination therewith the protective device can also comprise a force measuring sensor. In correspondence with the preceding explanations the lighting means, which emits possibly red light, is switched on as soon as a user exerts a force on the protective device.

Moreover, the protective device can comprise at least one warning notice which is backlit by the illuminable panel when the lighting means is switched on. This warning notice can be printed or glued onto the side surface of the fifth layer or engraved in the fifth layer.

As mentioned further above, the elevator cage of an elevator can also be equipped with illuminable panels. The elevator cage usually comprises a cage frame. Cage walls, optionally a cage door, a cage floor and a cage roof are fastened to the cage frame. Each of these parts has a surface which according to the wish of the operator can be provided with at least one illuminable panel. The illuminable panels themselves possibly form the cage walls, in a given case the cage door, cage floor and/or cage roof. An elevator cage provided with an illuminable panels should comprise at least one lighting means which is arranged at at least one edge region of the at least illuminable panel.

### BRIEF DESCRIPTION OF THE DRAWINGS

The disclosed technologies are further explained with reference to the drawings, in which:

FIG. 1 shows, schematically, in plan view an escalator with a support structure, with balustrades and with a protective device, which have illuminable panels;

FIG. 2 shows the escalator of FIG. 1 in the cross-section A-A;

FIG. 3 shows a detail view of the detail B indicated in FIG. 2, in which a corner region of the support structure is illustrated with an illuminable panel as a side cladding panel and with an illuminable panel as an under-view cladding panel;

FIG. 4 shows, in three-dimensional view to enlarged scale, a detail of the side cladding panel, which is shown in FIG. 3, from the viewing direction C indicated in FIG. 3; and

FIG. 5 shows, schematically and in sectional plan view, an elevator with an elevator cage, the cage walls and cage roof of which are illuminable panels.

### DETAILED DESCRIPTION

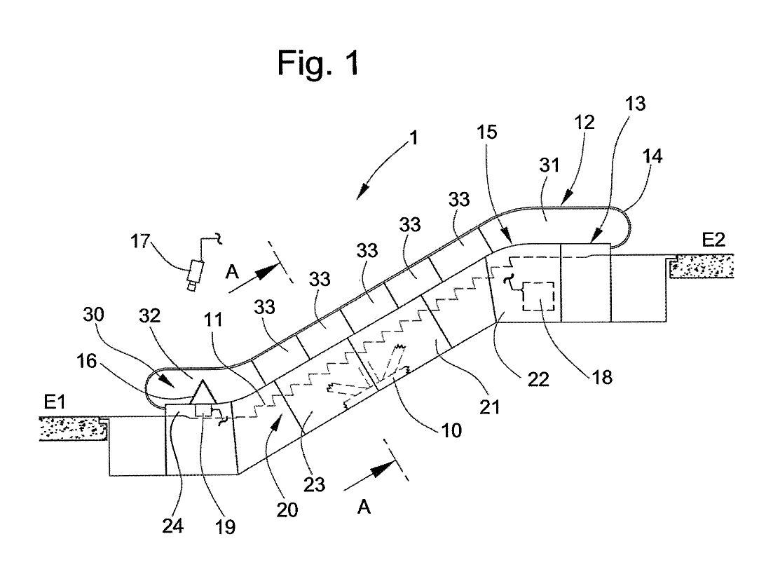

An escalator 1 with a support structure 10 is illustrated schematically in FIG. 1 in plan view. The escalator 1 connects a lower plane E1 with an upper plane E2. Arranged in the support structure 10 is a circulating step belt 11 which is deflected in the upper plane E2 and in the lower plane E1 and thus has a forward running section and a return running section. For the sake of better clarity, illustration of the return running section was dispensed with, as well as illustration of frames, guide rails, rail blocks and a drive unit. The escalator 1 further comprises two balustrades 12 which extend along each longitudinal side of the step belt 11, wherein in FIG. 1 only the balustrade 12 disposed at the front in the viewing plane is visible. A handrail 14 is arranged at each balustrade 12 to circulate, wherein the return running section thereof is arranged in a balustrade base 13 which connects the balustrade 12 with the support structure 10. At least one side of the support structure 10 is clad by an illuminable panel 20, wherein this is subdivided into a plurality of panel sections 21, 22, 23 and 24. The panel sections 21, 22, 23 and 24 extend in height over the support structure 10 and the balustrade base 13.

In addition, one of the possible advantages of the construction of the illuminable panels, such as disclosed in the preceding text, is shown in FIG. 1. The illuminable panels can have in the area dimension thereof, by which is meant the profile of the side surface thereof, almost all conceivable forms. In the exemplifying embodiment of FIG. 1 a first panel section 21 of the illuminable side cladding panel 20 has a rectangular side surface and the side surface of a second panel section 22 is matched to the profiles, which are to be clad, by a transition radius 15 and the balustrade base 13 running out.

The balustrade 12 can also have at least one illuminable panel. This illuminable balustrade cladding panel 30 is also subdivided into a plurality of panel sections 31, 32 and 33. In order to keep production costs as low as possible, the illuminable balustrade cladding panel 30 comprises a plurality of middle panel sections 33, the rectangular side surfaces of which have identical dimensions in length and height. An upper panel section 21 and a lower panel section 32 are adapted in the area extent thereof to the profile of the balustrade 12 in these regions and to the respectively adjoining middle panel section 33.

A protective device 16 is arranged laterally of the balustrade 12 in the region of the lower panel section 32. This is to prevent users misusing from the escalator 1 for escalator ‘surfing’. The protective device 16 in the present example is an illuminable panel, the light-emitting side surface of which is directed in the direction of the handrail deflection of the handrail 14. The illumination of the protective device 16 can be switched on permanently. Its protective and warning effect can be, however, more efficient if it is switched on only when a risk threatens. In order to achieve this, a force measuring sensor 19, for example, can be coupled with the protective device 16, which sensor detects a force acting on the protective device 16. The signal thereof can be passed on to a control 18 of the escalator 1, which on the basis of the received signal switches on a lighting means of the protective device 16.

A further possibility consists in monitoring a predetermined region around the protective device 16 by means of a movement sensor 17. In the present example, a video camera is schematically illustrated as movement sensor 17, the image sequences of which video camera can be analyzed by means of an image processing program continuously or in discrete steps. As soon as an object or a user has penetrated into the predetermined region, a signal is transmitted to the control 18 of the escalator 1. The received signal can be evaluated in the control 18, in which case the illumination of the protective device 16 is switched on depending on the kind and urgency and in a given case the step belt 11 and the handrail 14 can be stopped. In order to enhance clarity, the signal lines between the sensors 17, 19 and the control 18 are shown interrupted. Wire-free transmission devices can also be used instead of the signal lines.

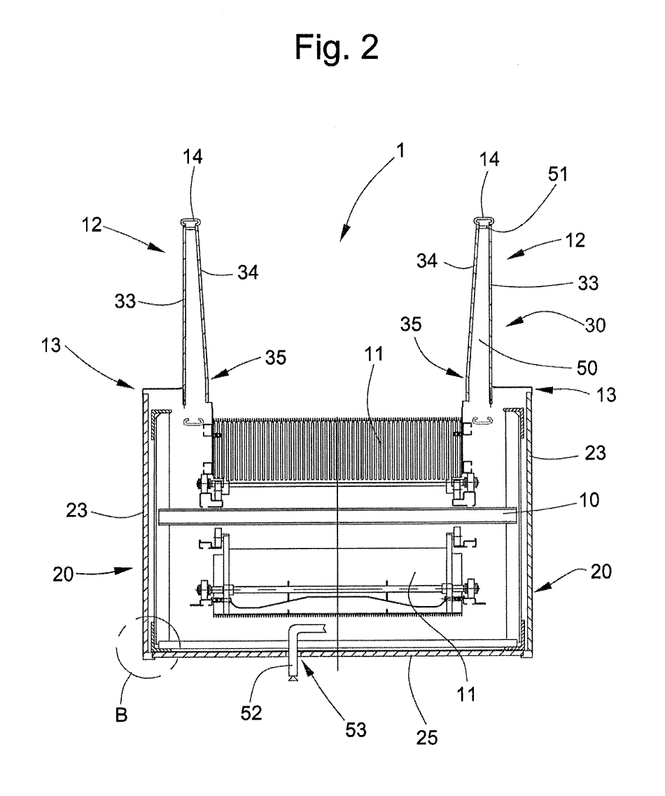

FIG. 2 shows the cross-section A-A, which is indicated in FIG. 1, of the escalator 1. In this FIG. 2 the arrangement of the step belt 11 in the support structure 10 and the two balustrades 12, which are connected with the support structure 10 by means of a balustrade base 13, can be readily seen. The guidance of the handrail 14 at the upper sides of the balustrades 12 and in the balustrade base 13 is also apparent. As the section A-A shows, the escalator 1 is clad on both sides with illuminable side cladding panels 20. The third panel sections 23, which are arranged in the section A-A, of the illuminable side cladding panels 20 are fastened to the support structure 10.

The under-view of the support structure 10 is provided with an illuminable under-view cladding panel 25. This is also fastened to the support structure 10. Thanks to the construction, which is disclosed in the preceding text, each illuminable panel 20, 25 can also have openings 53. The opening 53 illustrated in FIG. 2 enables passage of a sprinkler head 52 of a sprinkler installation (not illustrated in detail) through the under-view cladding panel 25.

The balustrade 12 has an internal structure 50 which supports a handrail guide 51 of the handrail 14. In addition, middle panel sections 33, which are arranged in the section A-A, of the illuminable balustrade cladding panel 30 are fastened to the inner structure 50. A respective illuminable inner balustrade cladding panel 34 is arranged on the inner sides of the balustrades 12 directed towards the step belt 11. These panels have a kink 35 extending in the longitudinal direction thereof. The illuminable panels 20, 25, 30 and 34 do not have to be designed to be absolutely flat, but can also have kinks 35 or be slightly bent. In a given case, the ideal arrangement of one or more lighting means has to be ascertained by tests in order to produce a light distribution which is as uniform as possible over the entire side surface of the illuminable panel 20, 25, 30, 34.

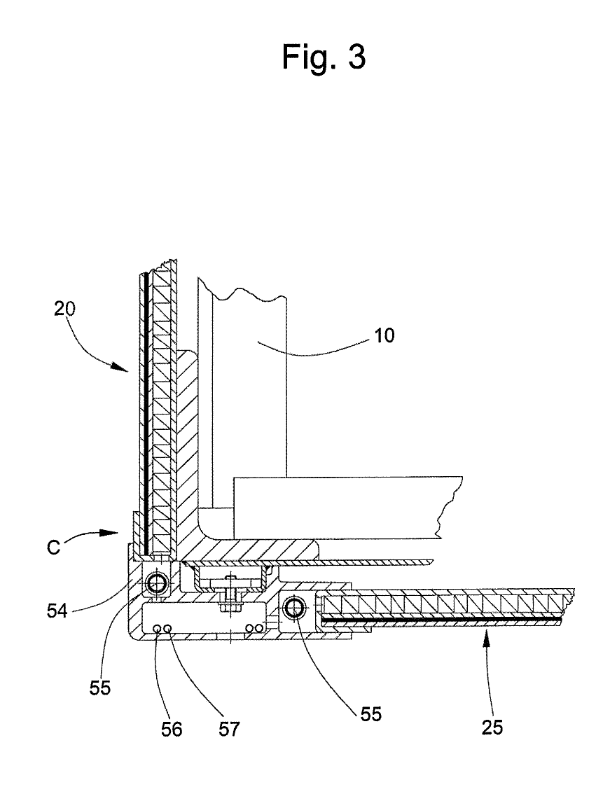

FIG. 3 illustrates a detail view of the detail B indicated in FIG. 2, which shows a corner region of the support structure 10 with the illuminable side cladding panel 20 and the illuminable under-view cladding panel 25. The two illuminable panels 20, 25 are held in a fastening section 54 and this is fixedly connected with the support structure 10. The fastening section 54 has cavities in which the lighting means 55 for illumination of the under-view cladding panel 25 and the side cladding panel 20 are arranged. Such fastening sections 54 are possibly constructed as aluminum extrusions. The illustrated fastening section 54 is only one of innumerable possibilities. The fastening section 54 can also be of multi-part construction. The two lighting means 55 are illustrated by way of example as fluorescent tubes, but obviously any forms of lighting means 55 can be used. Moreover, the fastening section 54 has sufficient interior space to accommodate supply cables 56 and signal lines 57. The lighting means 55 can, however, also be fastened directly to the illuminable side cladding panel 20 or to the illuminable under-view cladding panel 25.

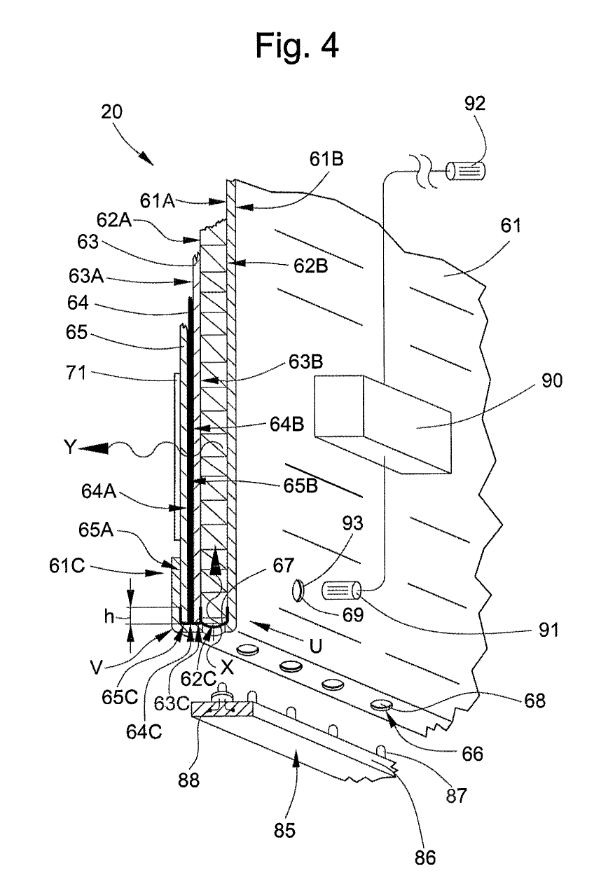

In order to better illustrate the construction of the illuminable panels, FIG. 4 shows in three-dimensional view to enlarged scale a detail of the side cladding panel 20 from the viewing direction C indicated in FIG. 3. All illuminable panels of FIGS. 1 to 3 have substantially the same layer sequence of the construction as the side cladding panel 20 illustrated in FIG. 4. A first layer of the construction is a reflective covering 61. In the case of the illustrated side cladding panel 20 this is a plate of steel or aluminum, which optionally has a reflective coating.

The second layer is a polymer material plate 62 containing light-dispersing particles, such as is marketed by, for example, the company Röhm under the product name ‘Plexiglas EndLighten’. The reflective covering 61 can also be a film or a coating applied to the polymer material plate 62 of the second layer. A third layer is a first transparent glass pane 63, a fourth layer is a transparent polymer layer 64 and a fifth layer is a second transparent glass pane 65. The third, fourth and fifth layers 63, 64 and 65 can also be fixedly connected together, for example as a composite glass pane. Each layer has two mutually opposite side surfaces 61A, 61B, 62A, 62B, 63A, 63B, 64A, 64B, 65A and 65B, the area extent of which is bounded by an edge region 61C, 62C, 63C, 64C or 65C. The edge regions 62C, 63C, 64C and 65C of the second to fifth layers are congruent in the present example. The area dimension of the reflective covering 61 is dimensioned to be somewhat larger so that, as illustrated in FIG. 4, an edge section of the edge region 61C of the first layer can be flanged. The flanging of the edge section 61C comprises two right-angled bent edges U, V, so that the edge regions 62C, 63C, 64C and 65C of the second to fifth layers are framed by the flanged edge section 61C.

A lighting means 85 is arranged below the illuminable side cladding panel 20. This comprises a strip-shaped flexible base body 86, which is provided with conductor strips 88 and on the upper side of which light-emitting diodes 87 are arranged. Light-emitting diodes 87 settable in light intensity and/or in color tone and/or in color saturation can be arranged.

In order that the light, which is emitted by the light-emitting diodes 87 and which is illustrated by the arrow X, can pass into the light-dispersing polymer material plate 62 of the second layer the flanged edge section 610 has passages 66 matched to the position and size of the light-emitting diodes 87. In concrete terms this can mean in the present example that the pitch of the passages 66 corresponds with the pitch of the light-emitting diodes 87 on the base body 85. In addition, the diameter of the individual passages 66 has to be dimensioned to be of such a size that as far as possible all emitted light can be fed into the polymer material plate 62. The light-dispersing particles embedded in the polymer material plate 62 of the second layer now deflect the light fed into the edge region 62C thereof so that this light issues at the side surface 62A from the second layer and penetrates through the third, fourth and fifth layers 63, 64 and 65. The light issues from the side surface 65A of the glass pane 65 of the fifth layer into the environment of the escalator or the moving walkway as symbolically illustrated by the arrow Y.

The two glass panes 63 and 65 of the third and fifth layers have a refractive index 1.45 to 2.14 (dimensionless size) typical for glass. The transparent polymer layer 64 of the fourth layer has a refractive index in the region of 1.48 to 1.56. In the case of use of different materials it is unlikely that the polymer layer 64 has exactly the same refractive index as the two glass panes 63, 65, but these differ only slightly from one another. This has the consequence that the light focused by scratches in the surface of the polymer plate 62 of the second layer as well as by optical contacts between the first and second layers and between the second and third layers is dispersed without being perceptibly broken down into the spectral colors of visible light. Even considered from a small distance, the illuminated side cladding panel 20 has by virtue of this construction a uniformly lit side surface corresponding with the side surface 65A of the second transparent glass pane 65. The side surface 65A of the fifth layer can, in addition, be covered by a motif film 71 or be provided with printing.

Through the construction, which comprises a plurality of layers 61, 62, 63, 64 and 65, of the side cladding panel 20 gaps between the individual layers are present, even when the layers 61, 62, 63, 64 and 65 bear tightly against one another. The gap width of the gaps joints depends on the non-planarity of the side surfaces 61A, 62A, 62B, 63A, 63B, 64A, 64B and 65B and stiffness of the individual layers 61, 62, 63, 64 and 65, which layered one on the other provide the construction of the side cladding panel 20. These gaps are very narrow and have a high level of capillarity. In order to prevent, for example, rainwater collecting in the gaps of the illuminable panels the gaps in the present exemplifying embodiment are sealed off all round in the edge regions 62C, 63C, 64C and 65C of the layers 61, 62, 63, 64 and 65 by means of a sealing element 67. The sealing element 67 has a joint depth h of 0.2 millimeters to 20 millimeters between the layers 61, 62, 63, 64 and 65. The joint depth is, however, also possibly 8 millimeters to 12 millimeters. Tightness is thereby securely imparted and the sealing element 67 can be concealed without problems by the flanged edge region 61C of the reflective covering 61 or by decorative strips without covering too much illuminable side surface 65A of the side cladding panel 20. Possibly, silicon rubber is used as sealing element 67. In order that entry of the light emitted by the lighting element 85 into the polymer material plate 62 of the second layer is not obstructed the sealing element 67 has cut-outs 68 matched to the lighting means 85 and the passages 66.

As shown in FIGS. 1 to 3, an escalator 1 or a moving walkway can have a plurality of illuminable panels 20, 25, 30 and 34 or panel sections 21, 22, 23, 24, 31, 32 and 33. At least one sensor 91, 92 can be associated with each illuminable panel 20, 25, 30 or 34 or panel section 21, 22, 23, 24, 31, 32 or 33 as is schematically illustrated in the exemplifying embodiment of FIG. 4. The sensor 91 of the side cladding panel 20 is arranged in the edge region thereof. In order that it can detect the light intensity and/or the color tone and/or the color saturation of the illuminated side cladding panel 20 the reflective covering 61 has a hole 93. This hole 93 cannot be seen by a user of the escalator of the moving walkway who observes the side surface 65C of the fifth layer 65 because this is covered by the flanged edge section 61C of the reflective covering 61. The hole 93 is possibly similarly provided with a seal 69 so that no liquids can penetrate between the reflective covering 61 and the polymer material plate 62. The signal of the sensor 91 is fed to a control unit 90 and can be processed by this.

FIG. 4 additionally shows a further sensor 92 which is associated with an illuminable panel (not illustrated), for example the under-view cladding panel 25 illustrated in FIG. 3. The control unit 90 can recognize, by way of the sensor signals of the sensors 91 and 92, whether or not all illuminable panels are illuminated. In addition, the sensor signal can be utilized for regulation of the light intensity and/or the color tone and/or color saturation of the associated panel. This makes it possible to selectably switch the panels or—if present—the panel sections in accordance with requirements of the operator of an escalator or a moving walkway, to vary the color tone, color saturation and light intensity and to influence, by these light accents, the awareness and mood of the user.

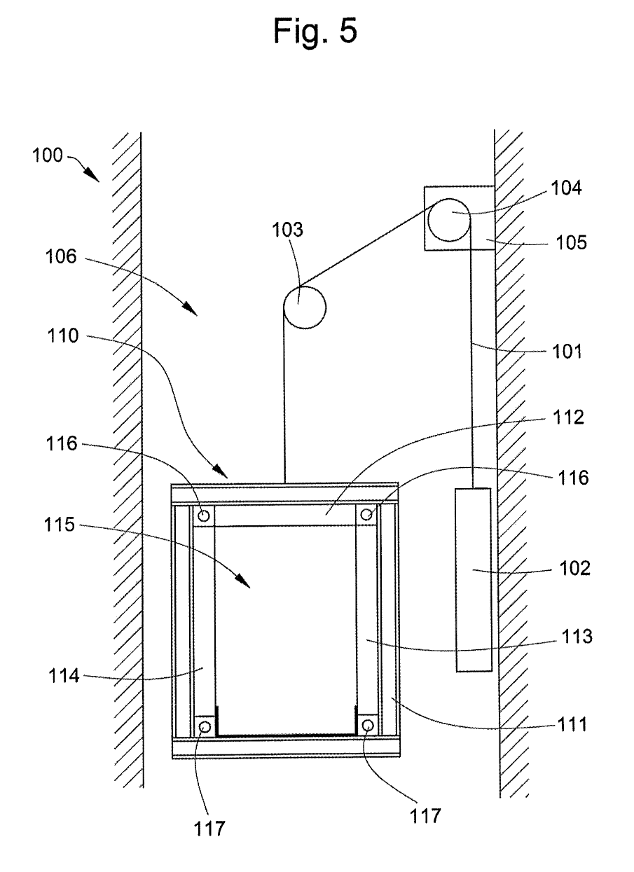

FIG. 5 shows schematically and in sectional plan view an elevator 100 with an elevator cage 110. The elevator cage 110 is connected with a counterweight 102 by a support means 101. The support means 101 is guided by way of a deflecting pulley 103 and a drive pulley 104. The drive pulley 104 is connected with a drive 105. The elevator cage 110, support means 101, counterweight 102, deflecting pulley 103, drive pulley 104 and drive 105 are arranged in an elevator shaft 106. The elevator cage 110 comprises a cage frame 111. Illuminable panels serving as cage roof 112 and cage walls 113 and 114 are fastened to the cage frame 111. The light-emitting side surfaces thereof are oriented towards the interior space 115 of the elevator cage 110. Lighting means 116 and 117 are arranged in the corner regions of the cage frame 111. The upper lighting means 116 arranged in the corner regions of the cage roof 112 feeds its emitted light at the edge not only into the illuminable panel of the cage roof 112, but also into the adjoining cage walls 113 and 114. The lighting means 116 and 117 can possibly be varied in light intensity and/or color tone and/or color saturation. The illuminable panel can thereby also be used as passenger information system. If, for example, any story of a parking building is hatched in a single color the color tone of the lighting means can be matched to the color of the respective story so that it is made known to the user at all times on exactly which story he or she is located.

Insofar as the elevator cage 110 is arranged in an elevator shaft 106 with transparent shaft walls the elevator cage 110 can also have illuminable panels, the light-emitting side surfaces of which are oriented towards the transparent shaft walls.

Although the disclosed technologies have been described by illustration of specific embodiments on the basis of an escalator and an elevator, these can also be used in a moving walkway and numerous further variants of embodiment. Thus, light can be supplied only into one edge section of the edge region of the polymer material plate. However, the light is possibly supplied to two mutually opposite edge sections. Lighting means can also be arranged to encircle the entire edge region of the polymer material plate and to supply light.

Moreover, not every surface of a moving walkway or an escalator has to be provided with an illuminable panel. For example, escalators and moving walkways for department stores can also have conventional glass balustrades instead of balustrades with illuminable balustrade cladding panels or only one illuminable under-view cladding panel can be provided. The illuminable side cladding panel, balustrade cladding panel or under-view cladding panel also does not have to cover the entire available area. Thus, for example, an illuminable side cladding panel can reach up to only half the height of the support structure.

Moreover, the illuminable panels can also have further transparent or semi-transparent layers between the afore-described layers. The enlarged layer sequence of these illuminable panels corresponds with the claimed construction notwithstanding the added layers, for which reason these are also embraced by the scope of protection. However, every additional layer reduces the light output of the illuminable panel.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. We therefore claim as our invention all that comes within the scope and spirit of these claims.

We claim:

1. An illuminable panel, comprising:
a plurality of layers, each layer of the plurality of layers comprising respective opposing side surfaces and being bounded by a respective edge region, a first layer of the plurality of layers comprising a reflective covering, a second layer of the plurality of layers comprising a transparent, edge-illuminable polymer material plate comprising light-dispersing particles, a third layer of the plurality of layers comprising a first glass pane, a fourth layer of the plurality of layers comprising a transparent polymer layer, and a fifth layer of the plurality of layers comprising a second glass pane.

2. The illuminable panel of claim 1, the first glass pane, the transparent polymer layer and the second glass pane forming a composite glass pane.

3. The illuminable panel of claim 1, the edge region of the reflective covering layer comprising a flanged edge section, and the respective edge regions of the second layer, third layer, fourth layer and fifth layer being framed by the flanged edge section.

4. The illuminable panel of claim 3, the flanged edge section comprising a passage for a lighting device.

5. The illuminable panel of claim 1, the illuminable panel further comprising a plurality of panel sections.

6. The illuminable panel of claim 5, further comprising an individual lighting device for a first one of the panel sections, the individual lighting device having at least one of a settable intensity, settable color or settable color saturation, the settable intensity, settable color or settable color saturation being independent of settings for an individual lighting device for a second one of the panel sections.

7. The illuminable panel of claim 6, further comprising a sensor for the first one of the panel sections, the sensor being configured to send to a control unit a signal for the at least one of the settable intensity, color or saturation of the individual lighting device of the first one of the panel sections.

8. The illuminable panel of claim 7, the first one of the panel sections being a master panel section, a third one of the panel sections being a servant panel section, at least one of the intensity, color or saturation of the individual lighting device of the third one of the panel sections being based on the signal from the sensor of the first one of the panel sections.

9. The illuminable panel of claim 1, further comprising gaps between at least a portion of the layers of the plurality of layers, the illuminable panel further comprising a sealing element for sealing the gaps, the sealing element being positioned around the respective edge regions, the sealing element having a joint depth between 0.2 mm and 20 mm.

10. The illuminable panel of claim 9, the sealing element having a joint depth between 8 mm and 12 mm.

11. The illuminable panel of claim 9, the sealing element having a cut-out for a lighting device.

12. The illuminable panel of claim 1, the fifth layer of the plurality of layers further comprising a motif film or printing, the motif film or printing being backlit when the illuminable panel is illuminated.

13. An escalator or moving walkway, comprising:
a support structure;
a belt arranged in the support structure;
a plurality of balustrades arranged at the support structure and extending at longitudinal sides of the belt;
an illuminable panel, the illuminable panel comprising a plurality of layers, each layer comprising respective opposing side surfaces, and each layer being bounded by a respective edge region, a first layer of the plurality of layers comprising a reflective covering, a second layer of the plurality of layers comprising a transparent, edge-illuminable polymer material plate comprising light-dispersing particles, a third layer of the plurality of layers comprising a first glass pane, a fourth layer of the plurality of layers comprising a transparent polymer layer, and a fifth layer of the plurality of layers comprising a second glass pane; and
a lighting device arranged at the respective edge regions of the plurality of layers.

14. The escalator or moving walkway of claim 13, the illuminable panel being a cladding panel, the reflective covering being directed toward the supporting structure.

15. The escalator or moving walkway of claim 13, the illuminable panel being a balustrade cladding panel of a balustrade, the reflective covering being directed toward an inner structure of the balustrade.

16. The escalator or moving walkway of claim 13, the illuminable panel being part of a protective device, the reflective covering being arranged on a side of the illuminable panel facing away from a field of view of a user of the escalator or moving walkway.

17. The escalator or moving walkway of claim 16, further comprising a movement sensor coupled to a control unit, the movement sensor being configured to monitor a region around the protective device, the lighting device being configured to switch on when a user enters the monitored region.

18. The escalator or moving walkway of claim 16, the protective device comprising a force measuring sensor, the lighting device being configured to switch on when a user exerts a force on the protective device.

19. The escalator or moving walkway of claim 16, the protective device comprising a warning notice, the warning device being backlit by the illuminable panel when the lighting device is switched on.

20. An elevator cage, comprising:
a cage frame;
a cage floor;
an illuminable panel connected to the cage frame, the illuminable panel comprising a plurality of layers, each layer of the plurality of layers comprising respective opposing side surfaces, and each layer of the plurality of layers being bounded by a respective edge region, a first layer of the plurality of layers comprising a reflective covering, a second layer of the plurality of layers comprising a transparent, edge-illuminable polymer material plate comprising light-dispersing particles, a third layer of the plurality of layers comprising a first glass pane, a fourth layer of the plurality of layers comprising a transparent polymer layer, and a fifth layer of the plurality of layers comprising a second glass pane; and
a lighting device arranged at the respective edge regions of the plurality of layers.
